(19) United States
(12) Patent Application Publication
(10) Pub. No.: US 2006/0231667 A1
(43) Pub. Date: Oct. 19, 2006

(54) Electronic apparatus with detachable support

(75) Inventor: Chun-Jung Tsuo, Taoyuan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/401,184

(22) Filed: Apr. 10, 2006

(30) Foreign Application Priority Data
Apr. 18, 2005 (TW) TW94112240

(51) Int. Cl. B60R 22/40; B65H 75/48

(52) U.S. Cl. 242/384.5; 248/917

(57) ABSTRACT

An electronic apparatus with a detachable support. The electronic apparatus includes a body, a release device, and a support. The body includes a housing. The release device is disposed on the housing in a manner such that it is moveable between a first position and a second position. When the release device is in the first position, it is engaged with the support so that the support is combined with the housing. When the release device is in the second position, it is disengaged from the support so that the support is separated from the housing.

### BACKGROUND

The invention relates to an electronic apparatus, and in particular, to an electronic apparatus with a detachable support.

In general, a liquid crystal display comprises a support that is typically detachable for convenient transport. Specifically, in a conventional liquid crystal display, a locking device for locking a detachable support is fixed to a large steel/metal member that is combined with a rear case of a screen of the liquid crystal display. To separate the support, the locking device is actuated via a button disposed on the rear case. Nevertheless, the cost of such a conventional liquid crystal display is higher, and its stability suffers.

### SUMMARY

Electronic apparatuses are provided. An exemplary embodiment of an electronic apparatus comprises a body, a release device, and a support. The body comprises a housing. The release device is disposed on the housing in a manner such that the release device is moveable between a first position and a second position. The support is detachably combined with the body. When the release device is in the first position, the release device is engaged with the support so that the support is combined with the housing. When the release device is in the second position, the release device is disengaged from the support so that the support is separated from the housing.

Furthermore, the release device comprises a moving member and an elastic member that may be a compression spring. The moving member is combined with the housing, and comprises a first hook with an inclined surface facing the support. The support comprises an engaging portion engaging the first hook when the release device is in the first position. The elastic member is located in the housing, and abuts the moving member to return the moving member to the first position. The housing comprises a slot and a through hole in which the first hook is located. The moving member comprises a second hook abutting the elastic member through the slot. The housing comprises a concave portion, communicating with the slot, in which the elastic member is disposed. The moving member comprises a locking portion and a handle portion. The first hook is formed on the locking portion, and the second hook is formed on the handle portion.

Note that the locking portion is made of metal, and the handle portion is made of plastic. The handle portion is combined with the locking portion by melting.

Additionally, the body comprises a screw combining the housing and the moving member. The housing comprises a through hole through which the screw passes. The through hole is oval-shaped so that the release device can be moved between the first position and the second position.

Moreover, the housing comprises a through hole. The support comprises a block inserted into the through hole SO that the support is combined with the body.

Note that the electronic apparatus may be a display such as a liquid crystal display, and the body may be a screen.

### DESCRIPTION OF THE DRAWINGS

The invention can be more fully understood by reading the subsequent detailed description and examples with references made to the accompanying drawings, wherein:

FIG. 1 is a schematic view of an embodiment of an electronic apparatus with a detachable support;

FIG. 2a is an exploded view of a housing and a release device in FIG. 1;

FIG. 2b is an enlarged view of a portion B in FIG. 2a ;

FIG. 2c is a plan view of the assembly of the housing and the release device;

FIG. 3 is a schematic view of the assembled release device;

FIG. 4 is a schematic view of the support in FIG. 1;

FIG. 5a is a plan view of the assembly of the housing and the release device, wherein the release device is located in a first position;

FIG. 5b is a cross-section along a line b-b in FIG. 5a; and

FIG. 5c is another cross section, wherein the release device is in a second position.

### DETAILED DESCRIPTION

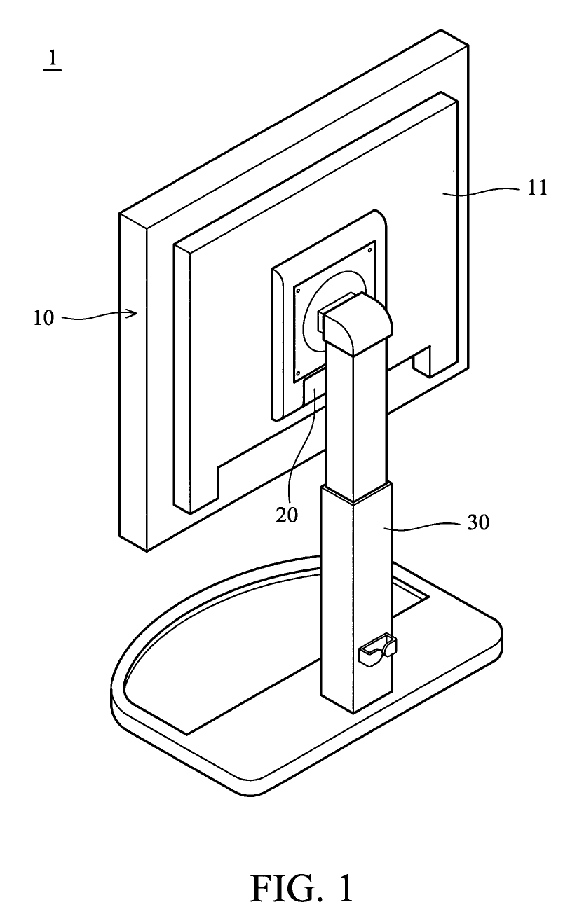

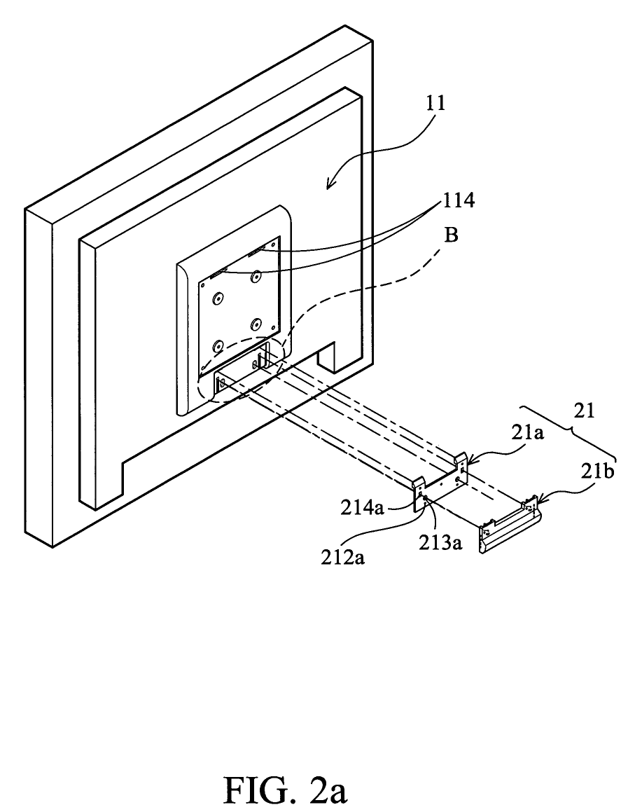

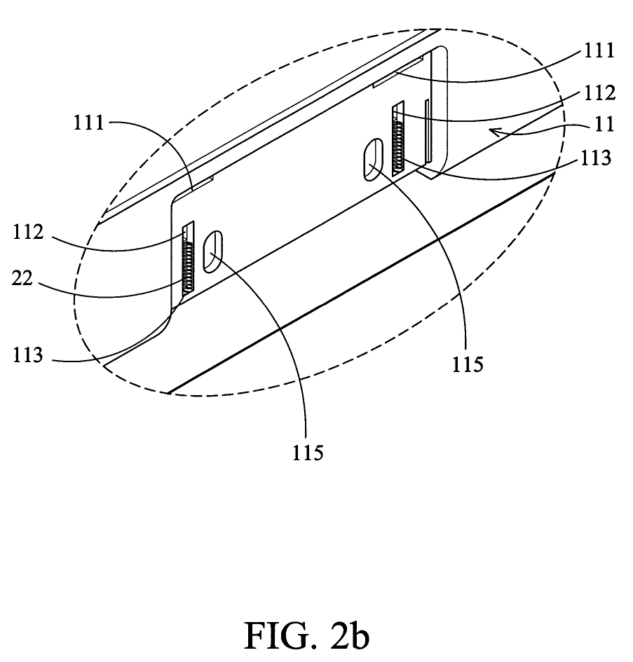

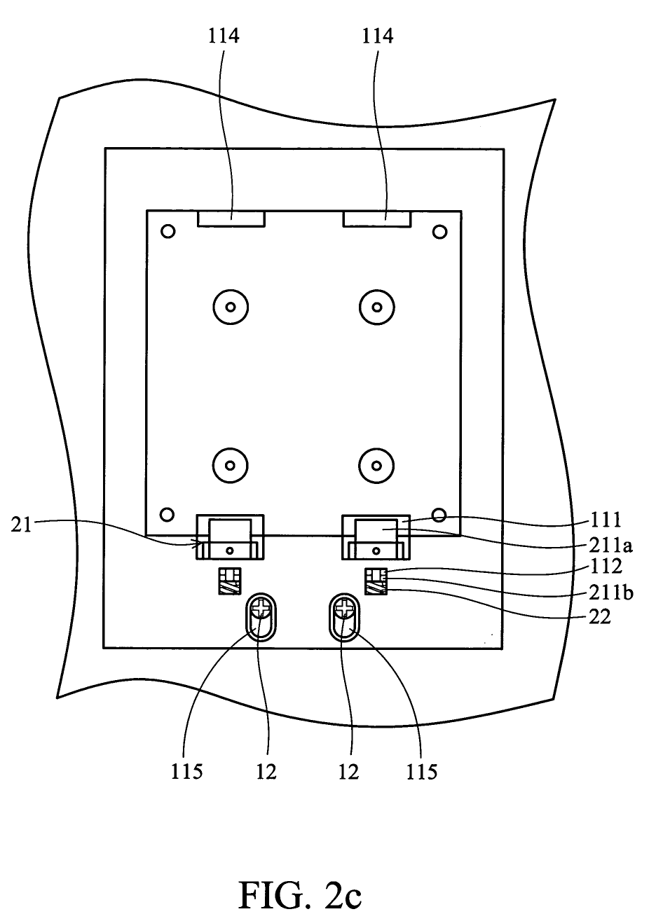

FIG. 1 is a schematic view of an embodiment of an electronic apparatus 1 comprising a body 10, a release device 20, and a support 30. The body 10 comprises a housing 11 and two screws 12, as shown in FIG. 2c. Note that the housing 11 in the figures is a rear case of the body 10.

Referring to FIGS. 2a and 2b, the housing 11 comprises two first through holes 111, two slots 112, two concave portions 113, two second through holes 114, and two third through holes 115. Each slot 112 is communicated with each concave portion 113. Each third through hole 115 is oval-shaped.

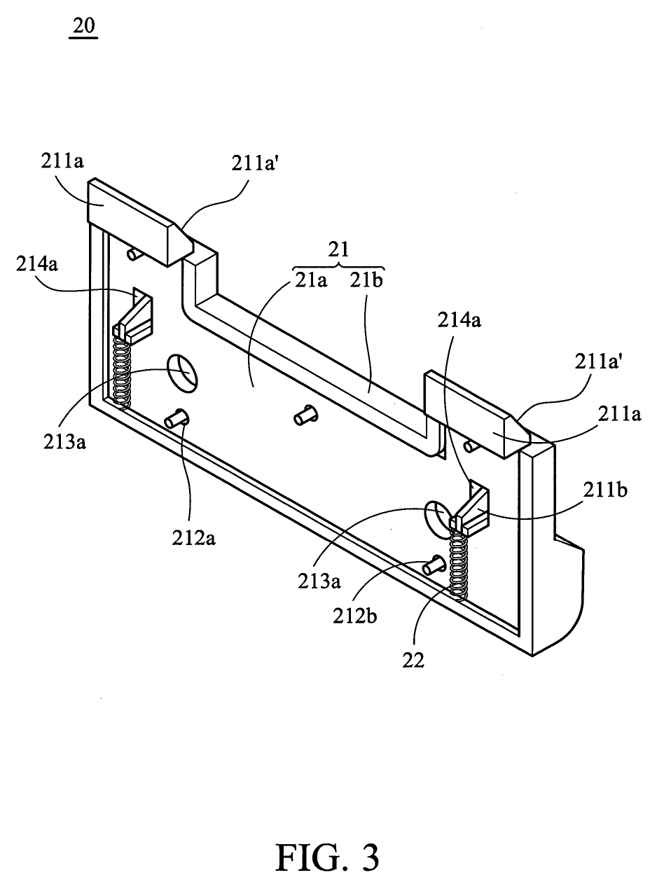

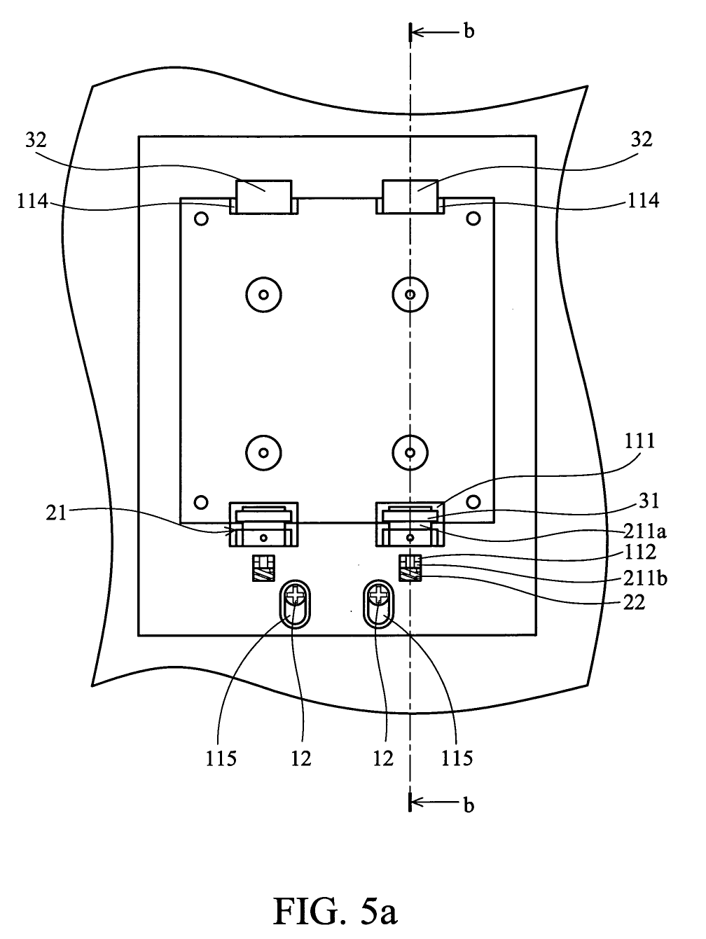

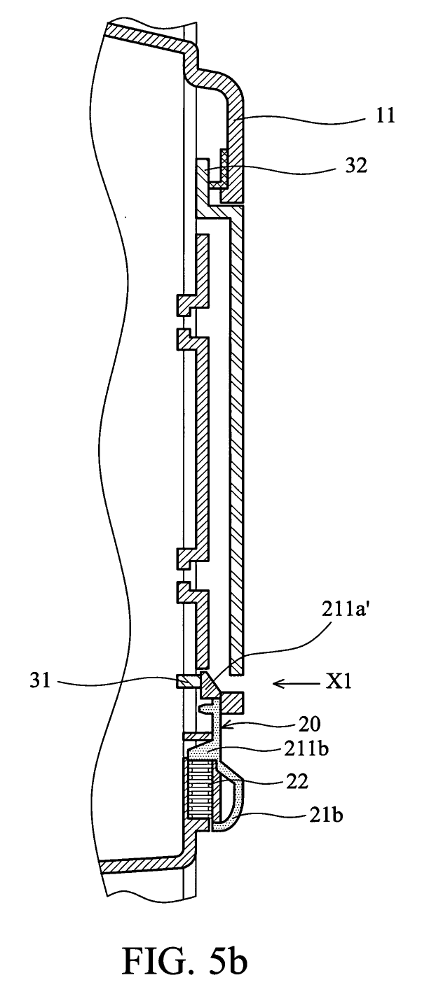

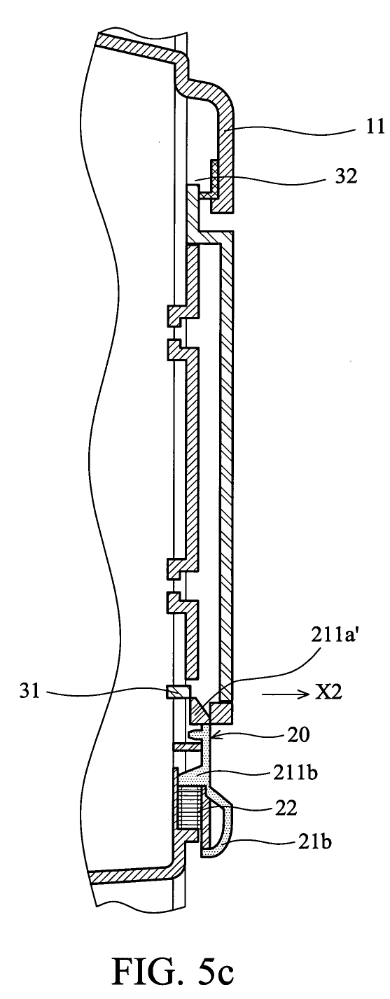

The release device 20 is disposed on the housing 11 in a manner such that the release device 20 is moveable between an engaging position (as shown in FIG. 5b and hereinafter referred to as a first position) and a separating position (as shown in FIG. 5c and hereinafter referred to as a second position). Referring to FIG. 3, the release device 20 comprises a moving member 21 and two elastic members 22. The moving member 21 comprises a locking portion 21a and a handle portion 21b, as shown in FIG. 2a.

As shown in FIG. 3, the locking portion 21a comprises two first hooks 211a, a plurality of first through holes 212a, two second through holes 213a, and two third through holes 214a. Each first hook 211a is formed at a top of the locking portion 21a, and is located in the first through hole 111 of the housing 11, as shown in FIG. 2c. Referring to FIG. 5b, each first hook 211a comprises an inclined surface 211a′ facing the support 30 (the outside of the housing 11). A rod 212b of the handle portion 21b passes through the first through hole 212a. The screw 12 passes through the second through hole 213a. A second hook 211b of the handle portion 21b passes through the third through hole 214a. The shape of the third through hole 214a corresponds to the shape of the second hook 211b.

The handle portion 21b comprises two second hooks 211b and a plurality of rods 212b. As previously described, the second hooks 211b and the rods 212b pass through the third through holes 214a and the first through holes 212a of the locking portion 21a respectively so as to enhance the convenience of the assembly between the locking portion 21a and the handle portion 21b. Each second hook 211b passes through the slot 112 of housing 11, as shown in FIG. 5a. Note that the locking portion 21a may be made of metal, and the handle portion 21b may be made of plastic. The handle portion 21b may be combined with the locking portion 21a by melting.

Note that the moving member comprises two components in this embodiment; however, it is not limited to this, and may comprise only one component. Additionally, although the number of both the rods 212b and the first through holes 212a is five, it is not limited to this as long as the number of the rod 212b corresponds to that of the first through hole 212a.

The elastic member 22 may be a compression spring to return the moving member 21 to the first position. As shown in FIG. 2b, the elastic member 22 is located in the concave portion 113 of the housing 11. Referring to FIG. 3, one side of the elastic member 22 abuts the locking portion 21a of the moving member 21 while the top end thereof abuts the second hook 212b of the handle portion 21b. Thus, the elastic member 22 is positioned in the concave portion 113 of the housing 11.

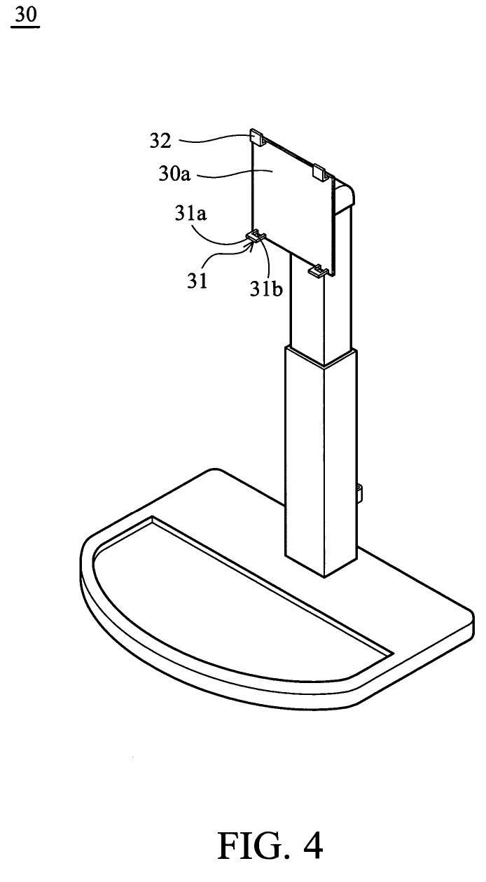

The support 30 is detachably combined with the body 10, and comprises a plate 30a as shown in FIG. 4. The plate 30a comprises two engaging portions 31 at a lower side, and two blocks 32 at an upper side. The support 30 is combined with the body 10 by inserting the first hooks 211a and the blocks 32 into the engaging portions 31 and the second holes 114.

The assembly process between the release device 20 and the body 10 is described in the following.

The elastic members 22 are first placed in the concave portions 113 of the housing 11, as shown in FIG. 2a. Then, the locking portion 21a and the handle portion 21b are assembled into the moving member 21, as shown in FIG. 3. After the moving member 21 is fixed to the housing 11 via the screws 12 as shown in FIG. 2c, the assembly between the release device 20 and the body 10 is finished. In the assembly of the release device 20 and the body 10, the first hooks 211a of the moving member 21 are located in the first through holes 111 of the housing 11, and the second hooks 211b pass through the slots 112 of the housing 11. Since the third through hole 115 of the housing 11 is oval-shaped, the release device 20 can be moved between the first position and the second position.

To combine the support 30 with the body 10, the blocks 32 of the plate 30a of the support 30 are first inserted into the second through holes 114 of the housing 11. Then, the engaging portions 31 of the plate 30a of the support 30 are engaged with the first hooks 211a of the moving member 21, as shown in FIGS. 5a and 5b. Note that before the engaging portion 31 is engaged with the first hook 211a, a front end 31a of the engaging portion 31 first contacts the inclined surface 211a′ of the first hook 211a. When the engaging portion 31 progresses in the direction X1 shown in FIG. 5b, the first hook 211a is correspondingly pressed downward along the inclined surface 211a′. After the front end 31a of the engaging portion 31 is separated from the first hook 211a, the first hook 211a returns to the first position by the elastic member 22 to engage with a hole 31b of the engaging portion 31.

To separate the support 30 from the body 10, the release device 20 is moved downward to the second position from the first position, as shown in FIG. 5c. At this time, the first hook 211a of the moving member 21 is separated from the engaging portion 31 of the support 30. Then, the plate 30a of the support 30 is moved in an X2 direction of FIG. 5c so that the release device 20 and the support 30 are completely separated. Finally, the block 32 of the plate 30a of the support 30 is separated from the second through hole 114 of the housing 11 to completely separate the support 30 from the body 10.

Note that the electronic apparatus is a display and the body is a screen in this embodiment; however, they are not limited to these. The concept can be applied to other electronic apparatuses requiring a detachable support. Additionally, the display may be a liquid crystal display.

As shown in FIGS. 5a and 5b, the plate 30a of the support 30 is combined with the housing 11 of the body 10 at both the upper and lower sides, thus obtaining higher stability.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic apparatus comprising:
a body comprising a housing;
a release device disposed on the housing in a manner such that the release device is moveable between a first position and a second position; and
a support detachably combined with the body, wherein the release device is engaged with the support so that the support is combined with the housing when the release device is in the first position, and the release device is disengaged from the support so that the support is separated from the housing when the release device is in the second position.

2. The electronic apparatus as claimed in claim 1, wherein the release device comprises:
a moving member combined with the housing; and
an elastic member, located in the housing, abutting the moving member to return the moving member to the first position.

3. The electronic apparatus as claimed in claim 2, wherein the moving member comprises a first hook, and the support comprises an engaging portion engaging the first hook when the release device is in the first position.

4. The electronic apparatus as claimed in claim 3, wherein the first hook comprises an inclined surface facing the support.

5. The electronic apparatus as claimed in claim 3, wherein the housing comprises a through hole in which the first hook is located.

6. The electronic apparatus as claimed in claim 3, wherein the housing comprises a slot, and the moving member comprises a second hook abutting the elastic member through the slot.

7. The electronic apparatus as claimed in claim 6, wherein the housing further comprises a concave portion, communicating with the slot, in which the elastic member is disposed.

8. The electronic apparatus as claimed in claim 6, wherein the moving member further comprises a locking portion and a handle portion, the first hook is formed on the locking portion, and the second hook is formed on the handle portion.

9. The electronic apparatus as claimed in claim 8, wherein the locking portion is made of metal, and the handle portion is made of plastic.

10. The electronic apparatus as claimed in claim 9, wherein the handle portion is combined with the locking portion by melting.

11. The electronic apparatus as claimed in claim 2, wherein the body further comprises a screw combining the housing and the moving member.

12. The electronic apparatus as claimed in claim 11, wherein the housing comprises a through hole through which the screw passes, and the through hole is oval-shaped so that the release device can be moved between the first position and the second position.

13. The electronic apparatus as claimed in claim 2, wherein the elastic member is a compression spring.

14. The electronic apparatus as claimed in claim 1, wherein the housing comprises a through hole, and the support comprises a block inserted into the through hole so that the support is combined with the body.

15. The electronic apparatus as claimed in claim 1, wherein the electronic apparatus is a display, and the body is a screen.

16. The electronic apparatus as claimed in claim 15, wherein the display is a liquid crystal display.
